(19) United States
(12) Patent Application Publication
(10) Pub. No.: US 2026/0321965 A1
(43) Pub. Date: Oct. 15, 2026

(54) Electronic Device

(71) Applicant: Honor Device Co., Ltd., Shenzhen (CN)

(72) Inventors: Yu Wang, Shenzhen (CN); Yin Meng, Shenzhen (CN); Yang Fan, Shenzhen (CN); Yubao Cao, Shenzhen (CN)

(21) Appl. No.: 19/692,938

(22) Filed: May 29, 2026

Related U.S. Application Data
(63) Continuation of application No. PCT/CN2024/109223, filed on Aug. 1, 2024.

(30) Foreign Application Priority Data
Dec. 8, 2023 (CN) 202311688074.4

(51) Int. Cl. H01Q 1/24; H04M 1/02

(52) U.S. Cl. CPC H01Q 1/243; H04M 1/0262; H04M 1/0277

(57) ABSTRACT

Embodiments of this disclosure provide an electronic device. A circuit board includes an extension area. The extension area is located between the side frame and a battery housing and is provided with a ground point. The middle frame assembly further includes a first electrical connection structure. The first electrical connection structure includes a fixed part and a spring sheet part. The fixed part is fixedly connected to the first pad area of the antenna. The spring sheet part is located on a side of the fixed part close to the battery housing. The spring sheet part extends along the second direction. A first end of the spring sheet part is connected to the fixed part, and a second end of the spring sheet part is in a contact connection to the ground point of the circuit board.

### CROSS-REFERENCE TO RELATED APPLICATIONS

This is a continuation of International Patent Application No. PCT/CN2024/109223, filed on Aug. 1, 2024, which claims priority to Chinese Patent Application No. 202311688074.4, filed on Dec. 8, 2023, both of which are incorporated herein by reference in their entireties.

### TECHNICAL FIELD

This disclosure relates to the field of electronic device technologies, and in particular, to an electronic device.

### BACKGROUND

Intelligent terminals such as mobile phones need to communicate through a mobile communication network provided by an operator, and can further implement a communication connection between intelligent devices in various manners such as Wi-Fi, BLUETOOTH, and infrared. For a mobile phone, a communication signal is received or sent via an antenna. The antenna is generally located in a frame area of the mobile phone. The antenna may be separately electrically connected, through an electrical connection assembly, to a feed point and a ground point that are disposed on a circuit board of the mobile phone, so as to receive or send the signal.

In the related art, a battery housing is disposed inside the mobile phone. The battery housing is used for placing a battery. The circuit board is usually located at a top or a bottom of the battery housing. To ensure performance of the antenna, a distance between the feed point and the ground point on the circuit board in an extension direction of the antenna needs to be greater than 4.5 mm.

However, currently, with an increase in consumer demands, mobile phones are becoming thinner and thinner. To ensure a battery capacity, a dimension of the battery housing is increased in a length direction of the mobile phone. In addition, a dimension of the circuit board is reduced in the length direction of the mobile phone. To ensure that the distance between the feed point and the ground point that are disposed on the circuit board along the length direction of the mobile phone meets a requirement, a part of the circuit board needs to extend into an area between a side edge of the battery housing and the frame of the mobile phone, and the ground point or the feed point is disposed at the extended part.

Because the area between the side edge of the battery housing and the frame of the mobile phone is narrow, to ensure that the dimension of the battery housing is not affected, a width of the part of the circuit board extending into the side edge of the battery housing is narrow, and a thickness of the entire device is thin. However, an electrical connection assembly in the related art generally includes two parts, namely, a spring plate and a spring sheet that are separately disposed, where the spring sheet needs to meet a specific thickness requirement or width requirement. Therefore, the electrical connection assembly in the related art cannot be used to implement the electrical connection between the antenna and the part of the circuit board extending into the side edge of the battery housing.

### SUMMARY

An objective of embodiments of this disclosure is to provide an electronic device, to implement an electrical connection between an antenna and a circuit board at a narrow area inside the electronic device. Specific technical solutions are as follows:

An embodiment of this disclosure provides an electronic device, including: a display panel; a rear cover disposed opposite to the display panel; a middle frame assembly, including a middle plate and located between the display panel and the rear cover, where a battery housing is disposed on a side of the middle plate close to the rear cover or a side of the middle plate close to the display panel, and the battery housing is used to accommodate a battery; the middle frame assembly further includes a frame disposed around a periphery of the middle plate, where the frame includes a top frame, a bottom frame, and a side frame, the top frame and the bottom frame extend along a first direction, the side frame extends along a second direction, and the first direction is perpendicular to the second direction; an antenna formed by at least a partial area of the side frame, where a first pad area is disposed on a side surface of the antenna close to the middle plate, and the first pad area is located on a side of the battery housing in the first direction; a circuit board, including an extension area, where the extension area is located between the side frame and the battery housing, and the extension area is provided with a ground point, where the middle frame assembly further includes a first electrical connection structure, the first electrical connection structure includes a fixed part and a spring sheet part, the fixed part is fixedly connected to the first pad area of the antenna, the spring sheet part is located on a side of the fixed part close to the battery housing and has a gap with the battery housing, the spring sheet part extends along the second direction and has a first end and a second end in the second direction, the first end of the spring sheet part is connected to the fixed part, and the second end of the spring sheet part is in a contact connection to the ground point of the circuit board.

In this embodiment of this disclosure, the electronic device includes the middle frame assembly. The middle frame assembly includes the middle plate. The battery housing is disposed on the middle plate. The battery housing may be used for placing the battery. The middle frame assembly further includes the frame, and the frame may form the antenna of the electronic device. The electronic device further includes the circuit board. The circuit board is provided with the extension area. The extension area is located between the side frame and the battery housing. By disposing the extension area, when the dimension of the battery housing increases along the second direction (for example, a length direction of the electronic device), the circuit board may have sufficient space in the second direction to arrange the ground point and a feed point of the antenna. In this embodiment of this disclosure, the middle frame assembly further includes the first electrical connection structure. The first electrical connection structure includes the fixed part and the spring sheet part. The fixed part may be fixedly connected to the first pad area of the antenna. The spring sheet part is located on a side of the fixed part close to the battery housing. Because the spring sheet part extends along the second direction, for example, a direction parallel to the side frame, the dimension of the spring sheet part in the first direction, for example, a direction perpendicular to the side frame, can be small. Therefore, when space between the side frame and the battery housing is narrow, the spring sheet part can be accommodated between the side frame and the battery housing. Further, the first end of the spring sheet part is fixedly connected to the fixed part, and the second end of the spring sheet part extends along the second direction and is in a contact connection to the ground point of the circuit board, so that the dimension of the connection area between the spring sheet part and the circuit board in the first direction can be small, and the dimension of the extension area of the circuit board in the first direction can be small, thereby avoiding dimension compression of the battery housing in the first direction caused by the large dimension of the extension area in the first direction, and further avoiding a decrease in a battery capacity. In this way, an electrical connection between the antenna and the circuit board is implemented without affecting the battery capacity.

In some embodiments of this disclosure, the fixed part and the spring sheet part are integrally formed. The fixed part and the spring sheet part are integrally formed, so that the first electrical connection structure can be compact and small.

In some embodiments of this disclosure, a side of the circuit board close to the display panel is a top surface, and the ground point is located on the top surface of the circuit board. The spring sheet part is located on a side of the circuit board close to the display panel. The spring sheet part includes a flat plate subpart and an inclined subpart. A side surface of the flat plate subpart far away from the battery housing is connected to the fixed part, one end of the inclined subpart is connected to the flat plate subpart, and the other end of the inclined subpart extends in a direction toward the top surface of the circuit board and is in a contact connection to the ground point.

The flat plate subpart is disposed to facilitate connection to the fixed part. The inclined subpart is disposed and one end of the inclined subpart is fixed to the flat plate subpart, so that the other end of the inclined subpart is a movable end, and under a specific pressing force, the other end of the inclined subpart, for example, the movable end, can be abutted with the circuit board, thereby implementing a contact connection between the spring sheet part and the ground point of the circuit board with high stability.

In some embodiments of this disclosure, the middle frame assembly further includes a plastic member, and the plastic member is located between the frame and the middle plate. An accommodating groove is disposed on a side surface of the plastic member that faces away from the display panel, and the spring sheet part is accommodated in the accommodating groove.

By disposing the plastic member, a gap between the frame and the middle plate can be sealed, to prevent moisture that intrudes from the side of the display panel from entering space between the middle plate and the rear cover through the gap between the frame and the middle plate, thereby protecting components such as an electronic component and a battery that are located between the middle plate and the rear cover. Further, by disposing the accommodating groove on the plastic member, the spring sheet part can be installed in the accommodating groove, and a supporting force is provided for the spring sheet part in a thickness direction of the electronic device, so that the spring sheet part can be closely abutted with the circuit board.

In some embodiments of this disclosure, the accommodating groove is provided with a positioning part, and the flat plate subpart is provided with a limiting part matching the positioning part. By disposing the positioning part in the accommodating groove and the limiting part matching the positioning part on the flat plate subpart, it is convenient to locate the first electrical connection structure by matching the limiting part with the positioning part when the first electrical connection structure is installed, to ensure that after installation, the fixed part can be aligned with the first pad area, and the second end of the limiting part can be aligned with the ground point of the circuit board, thereby improving installation precision.

In some embodiments of this disclosure, the electronic device further includes a pressing plate, and the pressing plate is located on a side of the circuit board that faces away from the display panel. A clamping buckle is disposed on a side of the pressing plate close to the side frame, a clamping slot is disposed on the plastic member, and the clamping buckle is inserted into the clamping slot, so that a part of the pressing plate corresponding to the extension area of the circuit board is abutted with a side of the circuit board that faces away from the spring sheet part. In this way, in the thickness direction of the electronic device, locations of the pressing plate and the plastic member can be matched, to fix the first electrical connection structure and the circuit board that are located between the pressing plate and the plastic member, thereby ensuring stability of a connection between the circuit board and the first electrical connection structure.

In some embodiments of this disclosure, the second end of the spring sheet part is provided with a plating layer. Therefore, the second end of the spring sheet part can be protected, to improve corrosion resistance and wear resistance thereof, thereby improving reliability of a connection between the spring sheet part and the ground point.

In some embodiments of this disclosure, the circuit board is provided with a copper leakage area, and the ground point is located at the copper leakage area. By disposing the copper leakage area on the circuit board, a contact connection between the first electrical connection structure and the circuit board can be implemented, and the circuit board features a simple structure, making it easy to manufacture.

In some embodiments of this disclosure, the circuit board is provided with an inductive element, and the ground point is connected to a ground layer of the circuit board through the inductive element. Therefore, after the antenna is connected to the ground point through the first electrical connection structure, the antenna can be connected to the ground through the inductive element, which is beneficial to improving performance of the antenna.

In some embodiments of this disclosure, the circuit board further includes a primary area. The primary area is located on a side of the battery housing close to the top frame or the bottom frame, and the primary area is provided with the feed point. A second pad area is further disposed on a side surface of the antenna close to the middle plate, and the second pad area is disposed at an interval with the first pad area. The second pad area is located on a side of the primary area in the first direction, and the second pad area is electrically connected to the feed point of the circuit board through a second electrical connection structure. Therefore, the antenna can be electrically connected to a feed source (for example, a radio frequency module) on the circuit board through the feed point.

In some embodiments of this disclosure, in the first direction, a distance between the second pad area and the primary area is greater than a distance between the first pad area and the extension area. Therefore, if it is ensured that the distance between the feed point and the ground point in the second direction meets a requirement, a connection space between the first pad area and the ground point of the circuit board can be saved to implement an electrical connection between the antenna and the ground point of the circuit board in a narrow area, and a clearance area of the second pad area can be enlarged, thereby improving performance of the antenna.

In some embodiments of this disclosure, a part, on which the first pad area and the second pad area are disposed, of the antenna projects along a direction toward the middle plate, to form an extension part, and the first pad area and the second pad area are located on a side surface of the extension part close to the middle plate. Disposing the extension part not only facilitates a connection between the antenna and the circuit board, but also enables a part of the antenna on which the extension part is not disposed to have a large clearance area, thereby facilitating improving performance of the antenna.

In some embodiments of this disclosure, the second electrical connection structure includes a spring plate and a breakaway spring contact. The spring plate is fixedly connected to the second pad area, and the breakaway spring contact extends along the first direction. One end of the breakaway spring contact is abutted with the spring plate, and the other end of the breakaway spring contact is fixed on the circuit board. An electrical connection can be implemented through the second electrical connection structure when the spacing between the antenna and the circuit board is large. When the breakaway spring contact extends along the first direction, a current sent from the feed source of the circuit board can directly enter the antenna along the first direction, and a path through which the current flows is a straight line without turning. Therefore, the path through which the current flows is short, which is beneficial to improving performance of the antenna.

In some embodiments of this disclosure, the circuit board includes a primary board and a secondary board, and the primary board and the secondary board are respectively located at two sides of the battery housing along the second direction. A part of the secondary board extends between the side frame and the battery housing, to form the extension area. Because elements such as an inductor are usually integrated into the secondary board, a part of the secondary board forms the extension area, so that a ground point can be disposed on the secondary board, thereby facilitating implementing a connection between the antenna and the ground through the inductor.

In some embodiments of this disclosure, a part of the primary board extends between the side frame and the battery housing, to form the extension area. In an actual application, the extension area may be disposed according to a specific structure of the electronic device, so that the layout of the internal structure of the electronic device is more proper, and it is convenient to improve the conventional electronic device.

In some embodiments of this disclosure, the circuit board further includes a stand-alone board. The stand-alone board is located between the battery housing and the side frame, and the stand-alone board is used for forming the extension area. Therefore, the primary board and secondary board may be directly sourced from conventional products, making it easy to configure.

### BRIEF DESCRIPTION OF THE DISCLOSURE

To more clearly describe the technical solutions in embodiments of this disclosure, the following briefly describes accompanying drawings required for describing the embodiments. The accompanying drawings in the following descriptions show merely some embodiments of this disclosure, and a person of ordinary skill in the art may derive other embodiments from these accompanying drawings without creative efforts.

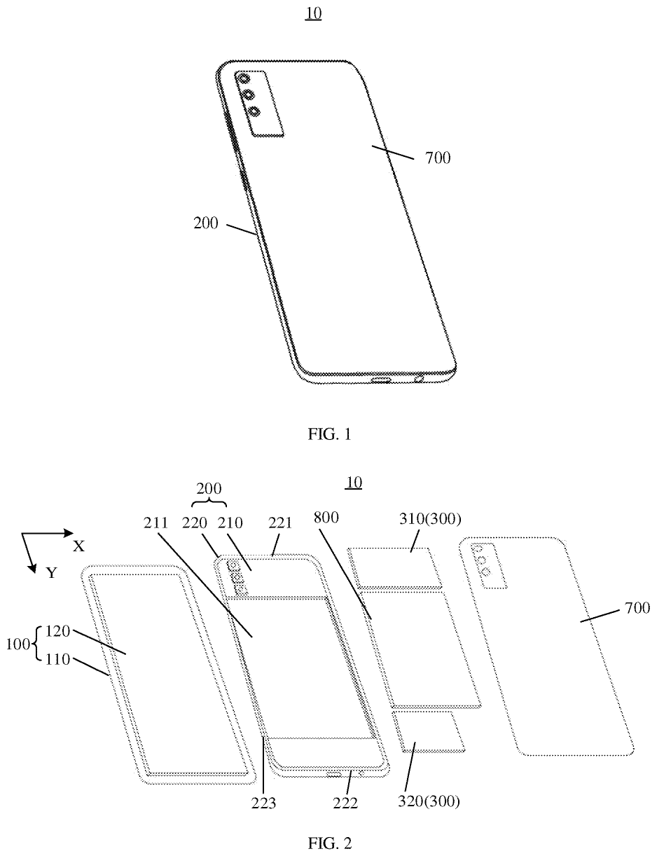

FIG. 1 is a schematic diagram of a structure of an electronic device according to an embodiment of this disclosure;

FIG. 2 is an exploded view of a structure of an embodiment of the electronic device shown in FIG. 1;

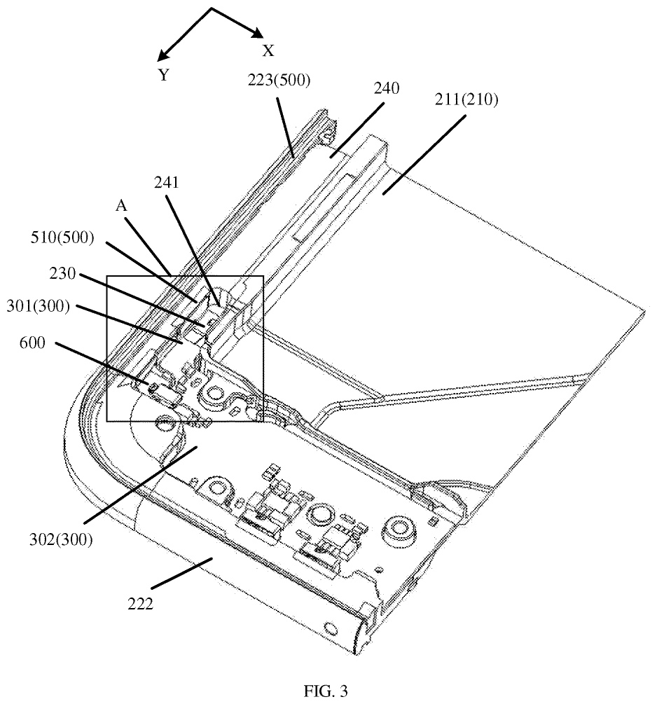

FIG. 3 is a partial schematic diagram of a structure of an electronic device according to an embodiment of this disclosure (a pressing plate is not shown);

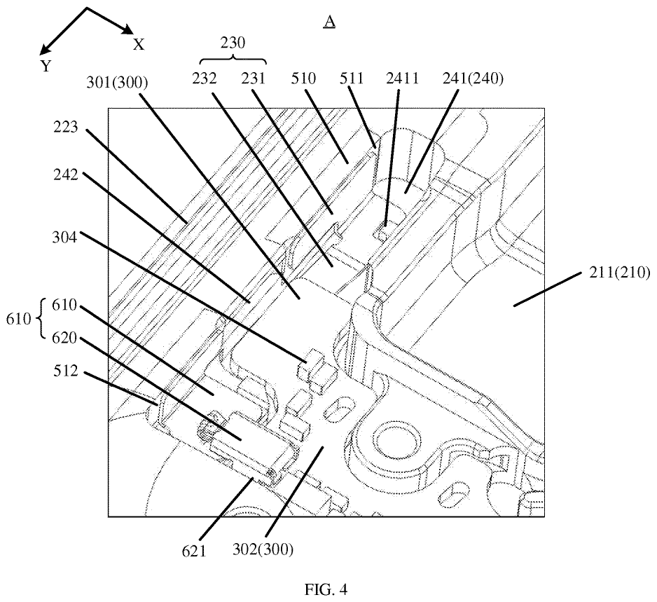

FIG. 4 is an enlarged schematic diagram of a part A in FIG. 3;

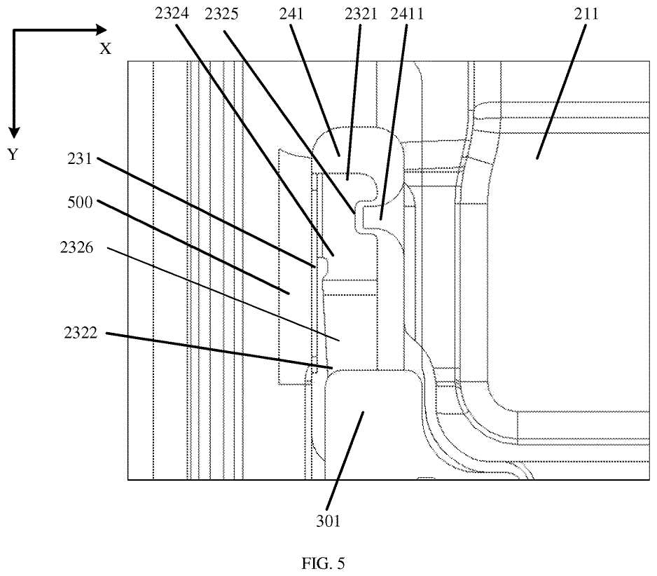

FIG. 5 is a top view of a connection between an antenna and an extension area of the electronic device shown in FIG. 3;

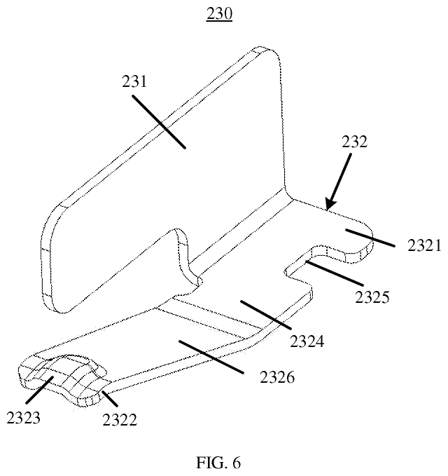

FIG. 6 is a schematic diagram of a first electrical connection structure of the electronic device shown in FIG. 3;

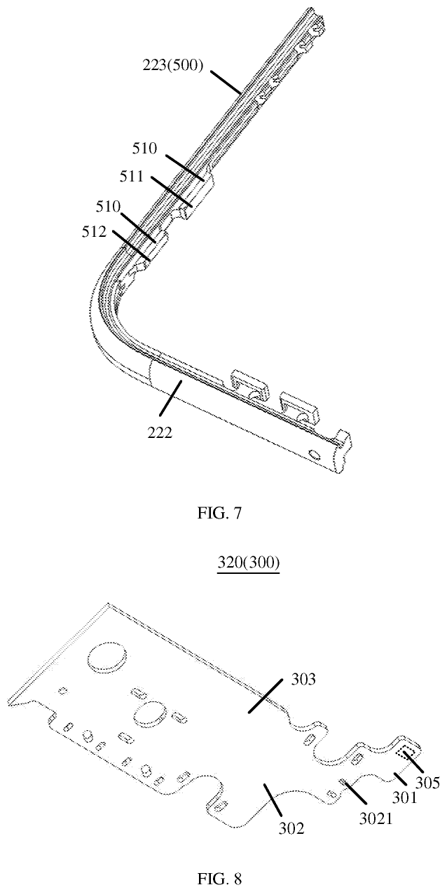

FIG. 7 is a schematic diagram of a structure of an antenna of the electronic device shown in FIG. 3;

FIG. 8 is a schematic diagram of a structure of a circuit board of the electronic device shown in FIG. 3;

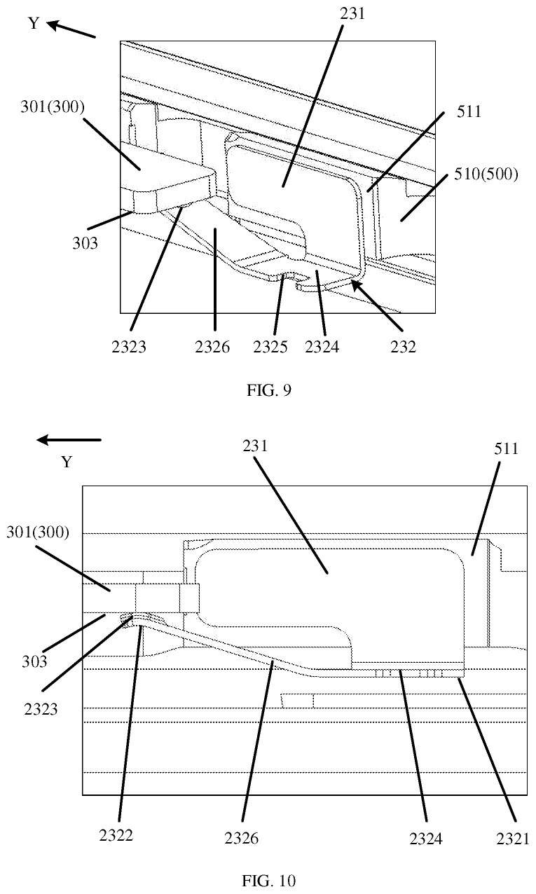

FIG. 9 is a schematic diagram of a connection among a first electrical connection structure, an antenna, and an extension area of the electronic device shown in FIG. 3;

FIG. 10 is a side view of FIG. 9;

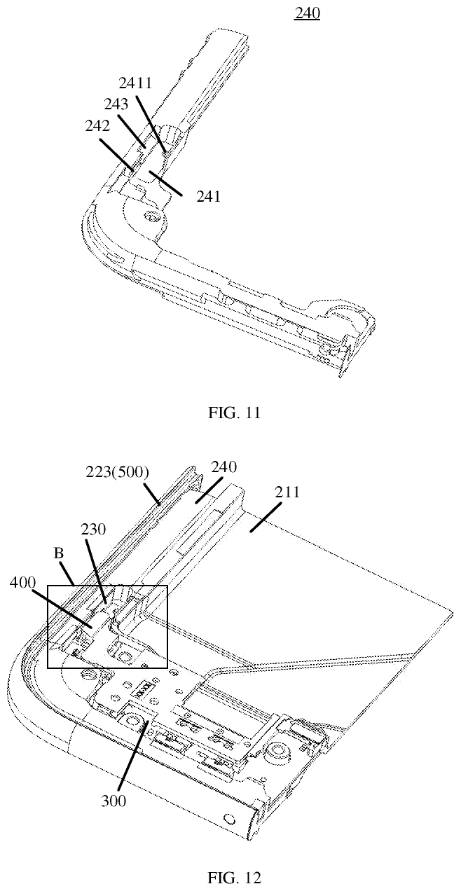

FIG. 11 is a schematic diagram of a structure of a plastic member of the electronic device shown in FIG. 3;

FIG. 12 is a partial schematic diagram of a structure of the electronic device shown in FIG. 3 with a pressing plate installed;

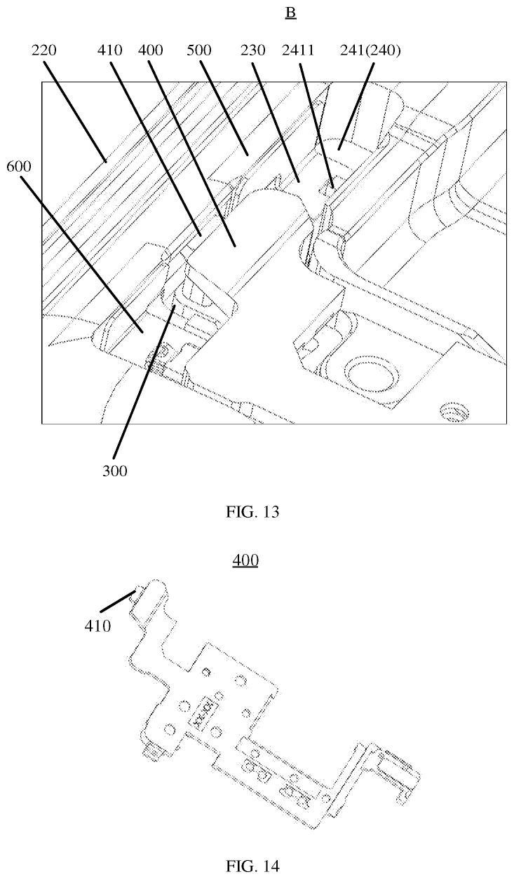

FIG. 13 is an enlarged schematic diagram of a part B in FIG. 12;

FIG. 14 is a schematic diagram of a structure of the pressing plate of the electronic device shown in FIG. 12; and

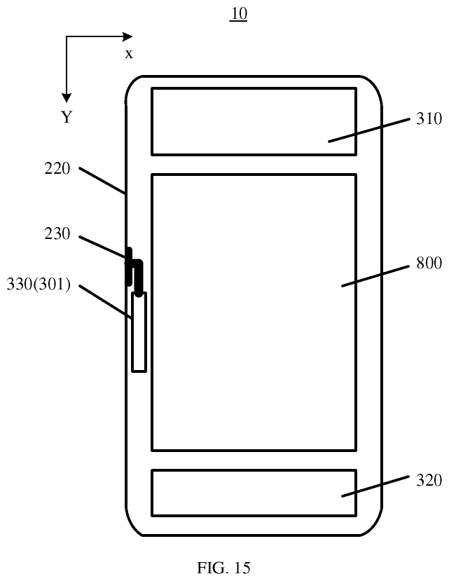

FIG. 15 is a schematic deployment diagram of another embodiment of the electronic device shown in FIG. 1.

### DESCRIPTION OF REFERENCE NUMERALS

Electronic device 10; display panel 100; light transmissive cover plate 110; display screen 120; middle frame assembly 200; middle plate 210; battery housing 211; frame 220; top frame 221; bottom frame 222; side frame 223; first electrical connection structure 230; fixed part 231; spring sheet part 232; first end 2321; second end 2322; plating layer 2323; flat plate subpart 2324; limiting part 2325; an inclined subpart 2326. plastic member 240; an accommodating groove 241; positioning part 2411; clamping slot 242; perforation 243; circuit board 300; an extension area 301; primary area 302; an opening 3021; top surface 303; an inductive element 304; copper leakage area 305; primary board 310; secondary board 320; stand-alone board 330; pressing plate 400; clamping buckle 410; an antenna 500; an extension part 510; first pad area 511; second pad area 512; second electrical connection structure 600; spring plate 610; breakaway spring contact 620; an in-line solder pin 621; rear cover 700; battery 800; first direction X; second direction Y.

### DESCRIPTION OF EMBODIMENTS

To make the objectives, technical solutions, and advantages of the present disclosure clearer and more comprehensible, the following further describes the present disclosure in detail with reference to the accompanying drawings and embodiments. The described embodiments are merely some of the embodiments of the present disclosure rather than all of the embodiments. Based on the embodiments of the present disclosure, all other embodiments obtained by a person of ordinary skill in the art shall fall within the protection scope of the present disclosure.

To better understand the technical solutions of this disclosure, the following describes embodiments of this disclosure in detail with reference to the accompanying drawings.

For ease of clear description of the technical solutions in the embodiments of this disclosure, in the embodiments of this disclosure, terms such as “first” and “second” are used to distinguish same items or similar items having basically same functions and usages. For example, a first connection part and a second connection part are used to distinguish different connection parts, and a sequence thereof is not limited. A person skilled in the art may understand that the terms such as “first” and “second” do not limit the quantity and position, and the terms such as “first” and “second” are not necessarily different either.

It should be noted that in this disclosure, terms such as “exemplary” or “for example” are used to represent as an example, an illustration, or a description. Any embodiment or design solution described as “exemplary” or “for example” in this disclosure should not be construed as preferred or advantageous over other embodiments or design solutions. Specifically, terms such as “exemplary” or “for example” is used to present related concepts in a specific manner.

Refer to FIG. 1 and FIG. 2. FIG. 1 is a schematic diagram of a structure of an electronic device 10 according to an embodiment of this disclosure, and FIG. 2 is an exploded view of a structure of an embodiment of the electronic device 10 shown in FIG. 1.

The electronic device 10 includes, but is not limited to, an electronic product having a wireless communications function, such as a mobile phone, a tablet computer (for example, a pad), a virtual reality (VR) device, a notebook computer, a personal computer (PC), an ultra-mobile personal computer (UMPC), a handheld computer, an intelligent wearable device, and a point of sales (POS). This embodiment of this disclosure is described by using an example in which the electronic device 10 is a mobile phone.

It may be understood that FIG. 1 and FIG. 2 only show some components of the electronic device 10 as an example, and actual shapes, actual dimensions, actual positions, and actual configurations of the components are not limited to FIG. 1 and FIG. 2.

As shown in FIG. 1 and FIG. 2, in this embodiment of this disclosure, the electronic device 10 includes a display panel 100, a rear cover 700, and a middle frame assembly 200. The rear cover 700 is disposed opposite to the display panel 100. The middle frame assembly 200 includes a middle plate 210. The middle plate 210 is located between the display panel 100 and the rear cover 700. A battery housing 211 is disposed on a side of the middle plate 210 close to the rear cover 700. The battery housing 211 is used to accommodate a battery 800. The middle frame assembly 200 further includes a frame 220 disposed around a periphery of the middle plate 210. The frame 220 includes a top frame 221, a bottom frame 222, and a side frame 223. The top frame 221 and the bottom frame 222 extend along a first direction X, the side frame 223 extends along a second direction Y, and the first direction X is perpendicular to the second direction Y.

Refer to FIG. 3 to FIG. 6. FIG. 3 is a partial schematic diagram of a structure of the electronic device 10 according to an embodiment of this disclosure; FIG. 4 is an enlarged schematic diagram of a part A in FIG. 3; FIG. 5 is a top view of a connection between an antenna 500 and an extension area 301 of the electronic device 10 shown in FIG. 3; and FIG. 6 is a schematic diagram of a first electrical connection structure 230 of the electronic device 10 shown in FIG. 3.

As shown in FIG. 3 to FIG. 6, in this embodiment of this disclosure, the electronic device 10 further includes the antenna 500 and a circuit board 300. The antenna 500 is formed by at least a partial area of the side frame 223. A first pad area 511 is disposed on a side surface of the antenna 500 close to the middle plate 210. The first pad area 511 is located on a side of the battery housing 211 in the first direction X. The circuit board 300 includes the extension area 301. The extension area 301 is located between the side frame 223 and the battery housing 211, and the extension area 301 is provided with a ground point.

The middle frame assembly 200 further includes a first electrical connection structure 230. The first electrical connection structure 230 includes a fixed part 231 and a spring sheet part 232. The fixed part 231 is fixedly connected to the first pad area 511 of the antenna 500. The spring sheet part 232 is located on a side of the fixed part 231 close to the battery housing 211 and has a gap with the battery housing 211. The spring sheet part 232 extends along the second direction Y and has a first end 2321 and a second end 2322 in the second direction Y. The first end 2321 of the spring sheet part 232 is connected to the fixed part 231, and the second end 2322 of the spring sheet part 232 is in a contact connection to the ground point of the circuit board 300.

In this embodiment of this disclosure, the electronic device 10 includes the middle frame assembly 200. The middle frame assembly 200 includes a middle plate 210, the battery housing 211 is disposed on the middle plate 210, and the battery housing 211 may be used to accommodate the battery 800. The middle frame assembly 200 further includes the frame 220, and the frame 220 may form the antenna 500 of the electronic device 10. The electronic device 10 further includes the circuit board 300. The circuit board 300 is provided with the extension area 301. The extension area 301 is located between the side frame 223 and the battery housing 211. By disposing the extension area 301, when the dimension of the battery housing 211 along the second direction Y (for example, a length direction of the electronic device 10) increases, the circuit board 300 can have sufficient space in this direction to arrange the ground point and a feed point of the antenna 500. In this embodiment of this disclosure, the middle frame assembly 200 further includes the first electrical connection structure 230. The first electrical connection structure 230 includes the fixed part 231 and the spring sheet part 232. The fixed part 231 may be fixedly connected to the first pad area 511 of the antenna 500. The spring sheet part 232 is located on a side of the fixed part 231 close to the battery housing 211. Because the spring sheet part 232 extends along the second direction Y, for example, a direction parallel to the side frame 223, the dimension of the spring sheet part 232 in the first direction X, for example, a direction perpendicular to the side frame 223 can be small. Therefore, when space between the side frame 223 and the battery housing 211 is narrow, the spring sheet part 232 can be accommodated between the side frame 223 and the battery housing 211. Further, the first end 2321 of the spring sheet part 232 is fixedly connected to the fixed part 231, and the second end 2322 of the spring sheet part 232 extends along the second direction Y and is in a contact connection with the ground point of the circuit board 300, so that the dimension of a connection area between the spring sheet part 232 and the circuit board 300 in the first direction X can be small, the dimension of the extension area 301 of the circuit board 300 in the first direction X can be small, thereby avoiding dimension compression of the battery housing 211 in the first direction X caused by the large dimension of the extension area 301 in the first direction X, and further avoiding a decrease in a capacity of the battery 800. In this way, an electrical connection between the antenna 500 and the circuit board 300 is implemented without affecting the capacity of the battery 800.

It should be understood that, in this embodiment of this disclosure, orientation terms such as “top” and “bottom” used in the description of the electronic device 10 are mainly based on an orientation when the electronic device 10 is held by a user. A position oriented to the top side of the electronic device 10 is referred to as a “top” and a position oriented to the bottom side of the electronic device 10 is referred to as a “bottom”. This does not indicate or imply that the indicated apparatus or element needs to have a specific orientation, and be constructed and operated in the specific orientation. Therefore, this cannot be understood as a limitation to an orientation of the electronic device 10 in an actual application scenario.

In this embodiment of this disclosure, the display panel 100 is used to display an image, a video, or the like. As shown in FIG. 2, the display panel 100 may include a light transmissive cover plate 110 and a display screen 120. The light transmissive cover plate 110 and the display screen 120 are disposed in a stacked manner and are fixedly connected by means of gluing or the like. The light transmissive cover plate 110 is mainly used to protect the display screen 120 and protect against dirt. The display screen 120 may be a flexible display screen, or may be a rigid display screen. The display screen may be an organic light-emitting diode display screen, an active-matrix organic light-emitting diode or an active-matrix organic light-emitting diode display screen, a mini light-emitting diode display screen, or the like.

The display panel 100 may be disposed on a side of the middle frame assembly 200 in a manner such as sticking, to fix the display panel 100 on the middle frame assembly 200. A side on which the display panel 100 is located constitutes a front surface of the electronic device 10. The rear cover 700 forms a housing of the electronic device 10. The rear cover 700 may be fixed on a side of the middle frame assembly 200 opposite to the display panel 100 in a manner such as sticking, clamping, or the like. The rear cover 700 is used to protect internal electronic components of the electronic device 10.

As shown in FIG. 2, the electronic device 10 may further include a battery 800. The battery 800 is accommodated in the battery housing 211. The battery 800 is used to supply power to electronic components, such as the circuit board 300, in the electronic device 10. In this embodiment of this disclosure, the battery housing 211 may be disposed on a side of the middle plate 210 close to the rear cover 700. In another embodiment of this disclosure, the battery housing 211 may be disposed on a side of the middle plate 210 close to the display panel 100. This is not limited in this disclosure.

In this embodiment of this disclosure, the first direction X may be a length direction of the electronic device 10, and the second direction Y may be a width direction of the electronic device 10. As shown in FIG. 2 and FIG. 3, on the middle plate 210, distances between the battery housing 211 and both the top frame 221 and the bottom frame 222 are both greater than a distance between the battery housing 211 and the side frame 223. Because the extension area 301 of the circuit board 300 is located between the battery housing 211 and the side frame 223, and there are gaps between the extension area 301 and both the of the battery housing 211 and the side frame 223, a distance of the extension area 301 of the circuit board 300 in the first direction X is narrow, and an electrical connection cannot be implemented to the extension area 301 of the circuit board 300 through an electrical connection assembly in the related art.

Specifically, in the related art, the electrical connection assembly generally includes a spring plate and a spring sheet. The spring plate is fixedly connected to the antenna, one end of the spring sheet is abutted with the spring plate, and the other end of the spring sheet is connected to the circuit board. The spring sheet generally includes structures such as an under-board spring contact and a breakaway spring contact.

In the related art, the under-board spring contact is generally disposed on a side of the circuit board 300 close to the display panel 100, and a height of the under-board spring contact is generally 6 mm. Because of a light and thin design of the electronic device 10, in a thickness direction of the electronic device 10, a gap between the side of the circuit board 300 close to the display panel 100 and the middle frame assembly 200 is small. If the under-board spring contact is used, the middle frame assembly 200 needs to be cracked, which affects waterproofness of the electronic device 10. Therefore, the under-board spring contact cannot be used to implement an electrical connection to the extension area 301 of the circuit board 300.

In the related art, generally, two pins are oppositely disposed on the breakaway spring contact, and two openings are correspondingly disposed on the circuit board. By soldering the pins in the openings, the breakaway spring contact is electrically connected to the circuit board 300. If the breakaway spring contact is used for electrical connection to the extension area 301, the extension area 301 needs to be provided with two openings. This not only increases the dimension of the extension area 301 in the first direction X, causing a reduction in the dimension of the battery housing 211, and a decrease in the capacity of the battery 800, but also increases the risk of scratching the spring sheet during assembly. In addition, extremely small width at the openings in extension area 301 causes a high risk of plate breaking. Therefore, the breakaway spring contact cannot be used to implement an electrical connection to the extension area 301 of the circuit board 300.

In addition, other spring structures in the related art are not suitable for electrical connection between the antenna 500 and the extension area 301 of the circuit board 300 due to problems such as low strength, complex technology, or large impact on performance of the antenna 500.

Different from the spring sheet structure in the related art, as shown in FIG. 4 and FIG. 5, when an electrical connection is implemented to the extension area 301 of the circuit board 300 through the first electrical connection structure 230 in this embodiment of this disclosure, because the spring sheet part 232 extends along the second direction Y, for example, a direction parallel to the side frame 223, the dimension of the spring sheet part 232 in the first direction X can be small, and the length of the spring sheet part 232 in the second direction Y can be long. The length of the spring sheet part 232 in the second direction Y is long, so that a height of the entire spring sheet part 232 is low, thereby avoiding interference with the middle frame assembly 200 in a thickness direction of the electronic device 10, and the spring sheet part 232 meets a requirement for an elastic force and exhibits high strength. Further, the dimension of the spring sheet part 232 in the first direction X is small, and the spring sheet part 232 is in a contact connection with the circuit board 300 after extending in the second direction Y, so that the dimension of a contact area between the spring sheet part 232 and the circuit board 300 in the first direction X is small, and the dimension of the extension area 301 of the circuit board 300 in the first direction X is small, thereby avoiding affecting the dimension of the battery housing 211, and further avoiding reducing the capacity of the battery 800. In addition, because the spring sheet part 232 is in a contact connection with the circuit board 300, the extension area 301 of the circuit board 300 also does not need to be provided with an opening, so that low strength of the extension area 301 can be avoided, which is beneficial to improving reliability of the extension area 301. In conclusion, by using the first electrical connection structure 230 in this embodiment of this disclosure, an electrical connection between the antenna 500 and the extension area 301 of the circuit board 300 can be implemented without affecting the capacity of the battery 800, and connection stability is good.

In this embodiment of this disclosure, the dimension of the spring sheet part 232 in the first direction X is less than or equal to 2 mm, and the height of the spring sheet part 232 in the thickness direction of the electronic device 10 is less than or equal to 0.5 mm.

In a specific embodiment, the dimension of the spring sheet part 232 in the first direction X is 1.2 mm, and the height of the spring sheet part 232 in the thickness direction of the electronic device 10 is 0.35 mm. In an actual application, the dimension of the spring sheet part 232 is related to the dimension of the electronic device 10. The dimension of the spring sheet part 232 varies with the dimension of the electronic device 10. This is not limited in this disclosure.

As shown in FIG. 6, in this embodiment of this disclosure, the fixed part 231 and the spring sheet part 232 of the first electrical connection structure 230 may be integrally formed. The fixed part 231 can play the role of the spring plate 610 in the related art. Therefore, the fixed part 231 and the spring sheet part 232 are integrally formed, so that the first electrical connection structure 230 is equivalent to integrating two structural parts, namely, the spring plate and the spring sheet, in the related art. In this way, the first electrical connection structure 230 can be compact and small.

In a specific embodiment, as shown in FIG. 4, the fixed part 231 may be a sheet-like structure. The fixed part 231 is fixed to the surface of the first pad area 511 of the antenna 500 by means of soldering.

Refer to FIG. 7 to FIG. 10. FIG. 7 is a schematic diagram of a structure of the antenna 500 of the electronic device 10 shown in FIG. 3; FIG. 8 is a schematic diagram of a structure of the circuit board of the electronic device shown in FIG. 3; FIG. 9 is a schematic diagram of a connection between the first electrical connection structure 230 and both the antenna 500 and the extension area 301 of the electronic device 10 shown in FIG. 3; and FIG. 10 is a side view of FIG. 9.

As shown in FIG. 4 and FIG. 7, in this embodiment of this disclosure, a part, on which the first pad area 511 is disposed, of the antenna 500 projects along a direction toward the middle plate 210, to form an extension part 510, and the first pad area 511 is located on a side surface of the extension part 510 close to the middle plate 210. Disposing the extension part 510 not only facilitates a connection between the antenna 500 and the circuit board 300, but also enables a part of the antenna 500 on which the extension part 510 is not disposed to have a large clearance area, thereby facilitating improving performance of the antenna 500. It should be noted that the clearance area mainly refers to a blank region around the antenna 500 of the electronic device 10. To ensure that the antenna 500 obtains a large bandwidth, a sufficient clearance area needs to be reserved for the antenna 500.

As shown in FIG. 5 and FIG. 8 to FIG. 10, in this embodiment of this disclosure, a side of the circuit board 300 close to the display panel 100 is a top surface 303, and the ground point is located on the top surface 303 of the circuit board 300. The spring sheet part 232 is located on a side of the circuit board 300 close to the display panel 100 (not shown in the figure). The spring sheet part 232 may include a flat plate subpart 2324 and an inclined subpart 2326. A side surface of the flat plate subpart 2324 that is away from the battery housing 211 is connected to the bottom of the fixed part 231. One end of the inclined subpart 2326 is connected to the flat plate subpart 2324. The other end of the inclined subpart 2326 extends along a direction toward the top surface 303 of the circuit board 300, and is in a contact connection with the ground point. The flat plate subpart 2324 is disposed to facilitate connection to the fixed part 231. The inclined subpart 2326 is disposed, and one end of the inclined subpart 2326 is fixed to the flat plate subpart 2324, so that the other end of the inclined subpart 2326 is a movable end. Under a specific pressing force, the other end of the inclined subpart 2326, for example, the movable end, may be abutted with the circuit board 300, thereby implementing a contact connection between the spring sheet part 232 and the ground point of the circuit board 300 with a high stability.

Further, as shown in FIG. 6, a second end 2322 of the spring sheet part 232 is provided with a plating layer 2323, for example, the movable end of the inclined subpart 2326 is provided with the plating layer 2323. Therefore, the second end 2322 of the spring sheet part 232 can be protected, to improve corrosion resistance and wear resistance thereof, thereby improving connection reliability between the spring sheet part 232 and the ground point. In a specific embodiment, material of the plating layer 2323 is gold or nickel.

As shown in FIG. 8, a copper leakage area 305 is disposed on the circuit board 300, and the ground point is located at the copper leakage area 305. By disposing the copper leakage area 305 on the circuit board 300, a contact connection between the first electrical connection structure 230 and the circuit board 300 can be implemented, and the circuit board features a simple structure, making it easy to manufacture.

Refer to FIG. 11. FIG. 11 is a schematic diagram of a structure of a plastic member 240 of the electronic device 10 shown in FIG. 3.

As shown in FIG. 3 to FIG. 5 and FIG. 11, in this embodiment of this disclosure, the middle frame assembly 200 further includes the plastic member 240. The plastic member 240 is located between the frame 220 and the middle plate 210. By disposing the plastic member 240, a gap between the frame 220 and the middle plate 210 can be sealed, to prevent moisture that intrudes from the side of the display panel 100 from entering space between the middle plate 210 and the rear cover 700 through the gap between the frame 220 and the middle plate 210, thereby protecting components such as an electronic component and the battery 800 that are located between the middle plate 210 and the rear cover 700.

Further, as shown in FIG. 11, the plastic member 240 is provided with a perforation 243 corresponding to the extension part 510 of the antenna 500, so that the extension part 510 is connected to the circuit board 300 after passing through the perforation 243.

As shown in FIG. 4, FIG. 5, and FIG. 11, an accommodating groove 241 is disposed on a side surface of the plastic member 240 that faces away from the display panel 100, and the spring sheet part 232 is accommodated in the accommodating groove 241. By disposing the accommodating groove 241 on the plastic member 240, the spring sheet part 232 can be installed in the accommodating groove 241, and a supporting force is provided for the spring sheet part 232 in a thickness direction of the electronic device 10, so that the spring sheet part 232 can be closely abutted with the circuit board 300.

Further, a positioning part 2411 is disposed in the accommodating groove 241, and the flat plate subpart 2324 is provided with a limiting part 2325 matching the positioning part 2411. By disposing the positioning part 2411 in the accommodating groove 241 and the limiting part 2325 matching the positioning part on the flat plate subpart 2324, it is convenient to locate the first electrical connection structure 230 by matching the limiting part 2325 with the positioning part 2411 when the first electrical connection structure 230 is installed, to ensure that after installation, the fixed part 231 can be aligned with the first pad area 511, and the second end 2322 of the limiting part 2325 can be aligned with the ground point of the circuit board, thereby improving installation precision.

In a specific embodiment, the positioning part 2411 is a protrusion that is disposed on one side wall of the accommodating groove 241 in a direction toward the spring sheet part 232, and the limiting part 2325 is a groove that is disposed on the flat plate subpart 2324 and that matches the protrusion structure. By matching the protrusion with the groove, the first electrical connection structure 230 can be located during installation.

Referring to FIG. 12 to FIG. 14, FIG. 12 is a schematic diagram of a structure of the electronic device 10 shown in FIG. 3 with a pressing plate 400 installed; FIG. 13 is an enlarged schematic diagram of a part B in FIG. 12; and FIG. 14 is a schematic diagram of a structure of the pressing plate 400 of the electronic device 10 shown in FIG. 12.

As shown in FIG. 12 to FIG. 14, in this embodiment of this disclosure, the electronic device 10 further includes the pressing plate 400. The pressing plate 400 is located on a side of the circuit board 300 that faces away from the display panel 100. By disposing the pressing plate 400, some electronic components clamped to the circuit board 300 may be fixed, to prevent some electronic components from falling down when the electronic device 10 shakes.

Further, as shown in FIG. 11, the plastic member 240 is provided with a clamping slot 242. As shown in FIG. 13, a clamping buckle 410 is disposed on a side of the pressing plate 400 close to the side frame 223. The clamping buckle 410 is inserted into the clamping slot 242, so that a part of the pressing plate 400 corresponding to the extension area 301 of the circuit board 300 is abutted with a side of the circuit board 300 that faces away from the spring sheet part 232. In this way, the pressing plate 400 may press the circuit board 300 in a thickness direction of the electronic device 10, so that the circuit board 300 is closely abutted with the first electrical connection structure 230. By disposing the clamping buckle 410 on the pressing plate 400, and the clamping buckle 242 on the plastic member 240, positions of the pressing plate 400 and the plastic member 240 can match with each other in a thickness direction of the electronic device 10, to fix the first electrical connection structure 230 and the circuit board 300 that are located between the pressing plate 400 and the plastic member 240, thereby ensuring stability of a connection between the circuit board 300 and the first electrical connection structure 230.

In this embodiment of this disclosure, as shown in FIG. 4, an inductive element 304 is disposed on the circuit board 300, and the ground point is connected to a ground layer of the circuit board 300 through the inductive element 304. Therefore, after the antenna 500 is connected to the ground point through the first electrical connection structure 230, the antenna 500 may be connected to the ground through the inductive element 304, which is beneficial to improving performance of the antenna 500.

It should be noted that, in the related art, the antenna may be directly connected to the ground by being connected to the middle plate. However, the direct connection to the ground reduces performance of the antenna. Therefore, in this embodiment of this disclosure, the antenna 500 is not directly connected to the middle plate 210 in the first direction X through the first electrical connection structure 230, but extends along the second direction Y to be connected to the circuit board 300 through the spring sheet part 232, so that the antenna 500 can be connected to the ground through the inductive element 304 disposed on the circuit board 300, which is beneficial to improving performance of the antenna 500.

In this embodiment of this disclosure, as shown in FIG. 3 and FIG. 4, the circuit board 300 further includes a primary area 302. The primary area 302 is located on a side of the battery housing 211 close to the bottom frame 222, and the primary area 302 is provided with the feed point. A second pad area 512 is further disposed on a side surface of the antenna 500 close to the middle plate 210. The second pad area 512 is disposed at an interval with the first pad area 511. The second pad area 512 is located on a side of the primary area 302 in the first direction X. The second pad area 512 is electrically connected to the feed point of the circuit board 300 through the second electrical connection structure 600. Therefore, the antenna 500 can be electrically connected to a feed source (for example, a radio frequency module) on the circuit board 300 through the feed point.

In this embodiment of this disclosure, as shown in FIG. 7, a part, on which the second pad area 512 is disposed, of the antenna 500 also projects along a direction toward the middle plate 210, to form the extension part 510. The second pad area 512 is located on a side surface of the extension part 510 close to the middle plate 210.

Further, as shown in FIG. 4, in the first direction X, a distance between the second pad area 512 and the primary area 302 of the circuit board 300 is greater than a distance between the first pad area 511 and the extension area 301.

Specifically, because the primary area 302 of the circuit board 300 is located on a side of the battery housing 211 close to the bottom frame 222, a distance between the primary area 302 and the side frame 223 does not affect the dimension of the battery housing 211. Therefore, the distance between the primary area 302 of the circuit board 300 and the side frame 223 can be large. Further, considering that a connection point between the antenna 500 and the ground point has a low requirement for a clearance area, and a connection point between the antenna 500 and the feed point requires a large clearance area, in this embodiment of this disclosure, the ground point is disposed in the extension area 301 of the circuit board 300, and the feed point is disposed in the primary area 302. In addition, in the first direction X, a distance between the second pad area 512 and the circuit board 300 is greater than a distance between the first pad area 511 and the circuit board 300. In this way, when it is ensured that a distance between the feed point and the ground point in the second direction Y meets a requirement, a connection space between the first pad area 511 and the ground point of the circuit board 300 can be saved, thereby implementing an electrical connection between the antenna 500 and the ground point of the circuit board 300 in a narrow area, and a clearance area of the second pad area 512 can be enlarged, thereby improving performance of the antenna 500.

In this embodiment of this disclosure, as shown in FIG. 4, the second pad area 512 is electrically connected to the feed point of the circuit board 300 through the second electrical connection structure 600. The second electrical connection structure 600 includes a spring plate 610 and a breakaway spring contact 620. The spring plate 610 is fixedly connected to the second pad area 512. The breakaway spring contact 620 extends along the first direction X. One end of the breakaway spring contact 620 is abutted with the spring plate 610, and the other end of the breakaway spring contact 620 is fixed on the circuit board 300. Considering that a distance between the second pad area 512 and the circuit board 300 is large, in this embodiment of this disclosure, the spring plate 610 and the breakaway spring contact 620 are separately disposed in the second electrical connection structure 600. One end of the breakaway spring contact 620 is abutted with the spring plate 610, and the other end of the breakaway spring contact 620 extends along the first direction X and is fixed to the circuit board 300. Therefore, a current sent from a feed source of the circuit board 300 can directly enter the antenna 500 along the first direction X, and a flowing path thereof is a straight line without turning, so that the flowing path is short, which is beneficial to improving performance of the antenna 500.

As shown in FIG. 4, in the second electrical connection structure 600, the spring plate 610 is an L-shaped structure. The spring plate 610 includes a vertical part and a horizontal part. The vertical part is directly fixed to the second pad area 512. One end of the breakaway spring contact 620 is abutted with the horizontal part of the spring plate 610, and the other end is provided with two in-line solder pins 621.

As shown in FIG. 8, an opening 3021 is provided at the feed point of the circuit board 300, and the in-line solder pin 621 of the breakaway spring contact 620 is soldered in the opening 3021. Therefore, an electrical connection between the antenna 500 and the feed point can be implemented through the second electrical connection structure 600.

In this embodiment of this disclosure, as shown in FIG. 1, the circuit board 300 includes a primary board 310 and a secondary board 320. The primary board 310 and the secondary board 320 are respectively located at two sides of the battery housing 211 along the second direction Y. The primary board 310 is located on a side of the battery housing 211 close to the top frame 221, and the primary board 310 is used to integrate control chips. In some embodiments, the primary board 310 may be electrically connected to the display panel 100. The secondary board 320 is located on a side of the battery housing 211 close to the bottom frame 222, and the secondary board 320 may be used to integrate electronic components such as a radio frequency front end and a universal serial bus device of the antenna 500. The primary board 310 and the secondary board 320 may be electrically connected through a flexible circuit board, a conducting wire, or the like.

In this embodiment of this disclosure, a part of the secondary board 320 extends between the side frame 223 and the battery housing 211, to form the extension area 301. A part of the secondary board 320 other than the extension area 301 is the primary area 302, and the ground point and the feed point are both disposed on the secondary board 320. Considering that components such as an inductor are usually integrated on the secondary board 320, a part of the secondary board 320 is extended between the side frame 223 and the battery housing 211 to form the extension area 301, and the ground point is located on the secondary board 320. It is convenient to implement an electrical connection between the ground point and the inductive element 304, so that an induction ground may be implemented after the antenna 500 is electrically connected to the ground, which is beneficial to improving performance of the antenna 500.

In another embodiment of this disclosure, according to a specific internal structure design of the electronic device 10, a part of the primary board 310 may alternatively be extended between the side frame 223 and the battery housing 211, to form the extension area 301, and a part of the primary board 310 other than the extension area 301 is the primary area 302. The ground point and the feed point may be disposed on the primary board 310, so that the internal structure layout of the electronic device 10 is more proper, and it is convenient to improve the conventional electronic device. This is not limited in this disclosure.

Refer to FIG. 15. FIG. 15 is a schematic deployment diagram of another embodiment of the electronic device 10 shown in FIG. 1.

As shown in FIG. 15, Embodiment 2 of this disclosure differs from Embodiment 1 in that in addition to the primary board 310 and the secondary board 320, the circuit board 300 may further include an additionally disposed stand-alone board 330. The stand-alone board 330 is located between the battery housing 211 and the side frame 223. The stand-alone board 330 is used for forming the extension area 301. The ground point may be disposed on the stand-alone board 330. The secondary board 320 or the primary board 310 may form the primary area 302, and the feed point is disposed on the secondary board 320 or the primary board 310. Therefore, the primary board 310 and the secondary board 320 may be directly sourced from conventional products, making it easy to configure.

It should be noted that in the examples and specification of this patent, relational terms such as first and second are used only to differentiate an entity or operation from another entity or operation, and do not require or imply any actual relationship or sequence between these entities or operations. In addition, the terms “include”, “comprise”, or any variants thereof are intended to cover a non-exclusive inclusion. Therefore, a process, method, object, or device that includes a series of elements not only includes such elements, but also includes other elements not specified expressly, or may include elements inherent to the process, method, object, or device. Unless otherwise specified, an element limited by “include a/an” does not exclude other same elements existing in the process, the method, the article, or the device that includes the element.

Although this disclosure is illustrated and described with reference to some embodiments of this disclosure, a person of ordinary skill in the art should understand that various changes in form and details may be made therein without departing from the spirit and scope of this disclosure.

What is claimed is:

1. An electronic device, comprising:
a display panel;
a rear cover disposed opposite to the display panel;
a middle frame assembly comprising:
a middle plate and located between the display panel and the rear cover, wherein a battery housing is disposed on a side of the middle plate close to the rear cover or a side of the middle plate close to the display panel, and wherein the battery housing is configured to accommodate a battery;
a frame disposed around a periphery of the middle plate, wherein the frame comprises a top frame, a bottom frame, and a side frame, wherein the top frame and the bottom frame extend along a first direction, wherein the side frame extends along a second direction, and wherein the first direction is perpendicular to the second direction;
an antenna formed by at least a partial area of the side frame, wherein a first pad area is disposed on a side surface of the antenna close to the middle plate, and wherein the first pad area is located on a side of the battery housing in the first direction; and
a circuit board comprising an extension area, wherein the extension area is located between the side frame and the battery housing, and wherein the extension area is provided with a ground point,
wherein the middle frame assembly further comprises a first electrical connection structure,
wherein the first electrical connection structure comprises a fixed part and a spring sheet part,
wherein the fixed part is fixedly connected to the first pad area of the antenna,
wherein the spring sheet part has a first end and a second end,
wherein the first end of the spring sheet part is connected to the fixed part, and
wherein the second end of the spring sheet part is in a contact connection to the ground point of the circuit board.

2. The electronic device of claim 1, wherein the spring sheet part is located on a side of the fixed part close to the battery housing and has a gap with the battery housing.

3. The electronic device of claim 2, wherein the spring sheet part extends along the second direction and has the first end and the second end in the second direction.

4. The electronic device of claim 3, wherein the fixed part and the spring sheet part are integrally formed.

5. The electronic device of claim 3, wherein a side of the circuit board close to the display panel is a top surface, wherein the ground point is located on the top surface of the circuit board, wherein the spring part is located on a side of the circuit board close to the display panel, wherein the spring sheet part comprises a flat plate subpart and an inclined subpart, wherein a side surface of the flat plate subpart far away from the battery housing is connected to the fixed part, wherein one end of the inclined subpart is connected to the flat plate subpart, and wherein the other end of the inclined subpart extends toward the top surface of the circuit board and is in a contact connection to the ground point.

6. The electronic device of claim 5, wherein the middle frame assembly further comprises a plastic member, and wherein the plastic member is located between the frame and the middle plate.

7. The electronic device of claim 6, wherein an accommodating groove is disposed on a side surface of the plastic member that faces away from the display panel, and wherein the spring sheet part is accommodated in the accommodating groove.

8. The electronic device of claim 6, wherein the accommodating groove is provided with a positioning part, and wherein the flat plate subpart is provided with a limiting part matching the positioning part.

9. The electronic device of claim 6, wherein the electronic device further comprises a pressing plate, wherein the pressing plate is located on a side of the circuit board that faces away from the display panel, wherein a clamping buckle is disposed on a side of the pressing plate close to the side frame, wherein a clamping slot is provided on the plastic member, and wherein the clamping buckle is inserted into the clamping slot so that a part of the pressing plate corresponding to the extension area of the circuit board is abutted with a side of the circuit board that faces away from the spring sheet part.

10. The electronic device of claim 3, wherein the second end of the spring sheet part is provided with a plating layer.

11. The electronic device of claim 3, wherein the circuit board is provided with a copper leakage area, and wherein the ground point is located at the copper leakage area.

12. The electronic device of claim 3, wherein the circuit board is provided with an inductive element, and wherein the ground point is connected to a ground layer of the circuit board through the inductive element.

13. The electronic device of claim 3, wherein the circuit board further comprises a primary area, wherein the primary area is located on a side of the battery housing close to the top frame or the bottom frame, wherein the primary area is provided with a feed point, wherein a second pad area is further disposed on a side surface of the antenna close to the middle plate, wherein the second pad area is located on a side of the primary area in the first direction, and wherein the second pad area is electrically connected to the feed point of the circuit board through a second electrical connection structure.

14. The electronic device of claim 13, wherein the second pad area is disposed at an interval with the first pad area.

15. The electronic device of claim 13, wherein in the first direction, a distance between the second pad area and the primary area is greater than a distance between the first pad area and the extension area.

16. The electronic device of claim 13, wherein a part of the antenna on which the first pad area and the second pad area are disposed protrudes along a direction toward the middle plate to form an extension part.

17. The electronic device of claim 16, wherein the first pad area and the second pad area are located on a side surface of the extension part close to the middle plate.

18. The electronic device of claim 13, wherein the second electrical connection structure comprises a spring plate, and wherein the spring plate is fixedly connected to the second pad area.

19. The electronic device of claim 18, wherein the second electrical connection structure further comprises a breakaway spring contact, wherein the breakaway spring contact extends along the first direction, wherein one end of the breakaway spring contact is abutted with the spring plate, and wherein the other end of the breakaway spring contact is fixed on the circuit board.

20. The electronic device of claim 1, wherein the circuit board comprises a primary board and a secondary board, wherein the primary board and the secondary board are respectively located at two sides of the battery housing along the second direction, and wherein:
a part of the secondary board extends between the side frame and the battery housing to form the extension area; or
a part of the primary board extends between the side frame and the battery housing to form the extension area; or
the circuit board further comprises a stand-alone board, wherein the stand-alone board is located between the battery housing and the side frame, and wherein the stand-alone board is configured to form the extension area.
